(19) United States
(12) Patent Application Publication
(10) Pub. No.: US 2022/0391756 A1
(43) Pub. Date: Dec. 8, 2022

(54) METHOD FOR TRAINING AN ARTIFICIAL INTELLIGENCE (AI) MODEL TO EXTRACT TARGET DATA FROM A DOCUMENT

(71) Applicant: Intelus Inc., Clyde Hill, WA (US)

(72) Inventors: Patrice Simard, Clyde Hill, WA (US); Riham Mansour, Redmond, WA (US)

(73) Assignee: Intelus Inc., Clyde Hill, WA (US)

(21) Appl. No.: 17/582,996

(22) Filed: Jan. 24, 2022

Related U.S. Application Data
(63) Continuation-in-part of application No. 17/410,608, filed on Aug. 24, 2021.
Application No. 17/410,608 is a continuation-in-part of application No. 17/337,726, filed on Jun. 3, 2021.

(51) Int. Cl. G06N 20/00

(52) U.S. Cl. CPC G06N 20/00

(57) ABSTRACT

A processor-implemented method includes (i) defining a region of interest ranging between a first and second boundary location for each label in the M documents that comprise N labels, (ii) summarizing information, in a selected document, from a first content location to the first boundary location of the region of interest to obtain a first summary that represents context information from the first content location to the first boundary location of the region of interest, (iii) summarizing information, in the selected document, from a second content location to the second boundary location to obtain a second summary that represents context information from the second boundary location to the second content location, (iv) performing training of the AI model including restricting training data from the M documents based on the region of interest, and (v) extracting the target data from the M documents using trained AI model.

### BACKGROUND

### Technical Field

Embodiments of this disclosure generally relate to predictive artificial intelligence (AI) models, and more particularly, to a method for training an artificial intelligence (AI) model to extract target data from M documents having N labels.

### Description of the Related Art

Artificial intelligence (AI) models have been trained to extract relevant information from long documents. Typically, training such an AI model requires a collection of labeled documents and multiple iterations are performed over each document. Because there are multiple iterations of training, it would be desirable to increase the speed of training. In a first iteration of training, each region of interest for each label may be determined on each document where there exists relevant information and the training may be limited to each region of interest to increase the speed. Each region of interest is a contiguous region in the document for a label for a set of documents.

In existing approaches, the region of interest is either a user-specified region or a self-determining region. For the user-specified region, a user may be able to adjust the boundaries of the region of interest at labelling time such that all labels are correct and independent of information that is outside the contiguous region. But the user-specified regions are often too inefficient to be practical for large documents where the regions of interest are large.

Further, in the self-determining region, a user assigns labels in various places in the document, and the region of interest may be determined based on that process. A challenge with self-determining regions is that a loss of information that may be critical to the performance of the AI model may occur, which is caused by the region of interest being too small. Hence, performance of the AI model is severely degraded. Therefore, even though an increase in the speed of training may be achieved, the AI model is prone to have severe degradation in performance when the AI model is deployed or tested.

Thus, there remains a need of a method to automatically extract the regions of interest to train an AI model so that the speed of training is improved without substantial degradation of performance.

### SUMMARY

In view of the foregoing, embodiments herein provide a processor-implemented method for training an artificial intelligence (AI) model to extract target data from M documents. The method includes (i) defining a region of interest that ranges between a first boundary location and a second boundary location for each label in each of the M documents, wherein M documents comprise N labels, wherein M is a positive integer greater than 0 and N is a positive integer greater than 1, (ii) summarizing information, in a selected document that is selected from M documents, from a first content location to the first boundary location of the region of interest to obtain a first summary at the first boundary location, wherein the first summary represents context information from the first content location in the selected document to the first boundary location of the region of interest, (iii) summarizing information, in the selected document, from a second content location to the second boundary location of the region of interest to obtain a second summary at the second boundary location, wherein the second summary represents context information from the second boundary location of the region of interest to the second content location in the selected document, (iv) performing a first occurrence of training of the AI model including restricting a training data from the M documents based on the region of interest for each of the N labels to obtain an original trained AI model, and (v) extracting the target data from the M documents using the original trained AI model.

The method summarizes context information around regions of interest such that training can be performed at high speed without significant loss of performance. The method automatically determines the region size for the regions of interest and represents the context information with sufficient accuracy to both maximize training speed and performance of the AI model.

In some embodiments, a subsequent trained AI model is obtained by (a) updating the first summary and the second summary of the region of interest based on a prediction of the original trained AI model and (b) performing a second occurrence of training of the original trained AI model including restricting the training data based on the updated region of interest for each of the N labels to obtain the subsequent trained AI model.

In some embodiments, the first summary and the second summary of the region of interest are updated based at least in part on repositioning of at least one of the first boundary location and the second boundary location to resize the region of interest into an updated region of interest for each of the N labels, wherein the updated region of interest is different from the region of interest.

In some embodiments, the method includes an iterative process comprising of alternating between step (a) and step (b) to obtain the subsequent trained AI model. The iterative process is stopped if performance of the prediction of the subsequent trained AI model after restricting the training data based on the updated region of interest exceeds a performance threshold of unrestricted prediction of the subsequent trained AI model.

A first region of interest of the selected document from the M documents and a second region of interest of the selected document are merged into a third region of interest of the selected document if the first region of interest and the second region of interest are overlapping.

In some embodiments, the first boundary location and the second boundary location for each of the N labels in the M documents are initialized at a first predetermined location and a second predetermined location, respectively, in the selected document and the first summary and the second summary are initialized using at least one of (a) a default value, (b) a value computed using a pre-trained AI model or (c) an AI model that is initialized with default parameter values.

In some embodiments, incremental training of the AI model is performed by (i) initializing the first boundary location and the second boundary location for each of the N labels in the M documents using a trained parameter of the original trained AI model obtained from a previous occurrence and (ii) performing Q repetitions of step (b) after one repetition of step (a), wherein Q is a positive integer for performing incremental training of the AI model.

In some embodiments, the region of interest of at least one of the N labels is expanded by (i) determining (a) a first error obtained in a prediction of the subsequent trained AI model after restricting the training data based on the updated region of interest and (b) a second error obtained in a prediction of the subsequent trained AI model without restricting the training data, (ii) determining that a difference between the first error and the second error is more than a threshold and (iii) expanding the region of interest for next occurrence of performing training of the original trained AI model.

Some embodiments described herein further comprise utilizing a first boundary location and a second boundary location of a previous iteration of training the original trained AI model by performing at least one iteration of incremental training of the original trained AI model. In another aspect, there is described a system for training an artificial intelligence (AI) model to extract target data from M documents, comprising: a processor and a non-transitory computer readable storage medium storing one or more sequences of instructions, which if executed by the processor, performs a method comprising (i) defining a region of interest that ranges between a first boundary location and a second boundary location for each label in each of the M documents, wherein M documents comprise N labels, wherein M is a positive integer greater than 0 and N is a positive integer greater than 1, (ii) summarizing information, in a selected document that is selected from M documents, from a first content location to the first boundary location of the region of interest to obtain a first summary at the first boundary location, wherein the first summary represents context information from the first content location in the selected document to the first boundary location of the region of interest, (iii) summarizing information, in the selected document, from a second content location to the second boundary location of the region of interest to obtain a second summary at the second boundary location, wherein the second summary represents context information from the second boundary location of the region of interest to the second content location in the selected document, (iv) performing a first occurrence of training of the AI model including restricting a training data from the M documents based on the region of interest for each of the N labels to obtain an original trained AI model, and (v) extracting the target data from the M documents using the original trained AI model.

In some embodiments, a subsequent trained AI model is obtained by (a) updating the first summary and the second summary of the region of interest based on a prediction of the original trained AI model and (b) performing a second occurrence of training of the original trained AI model including restricting the training data based on the updated region of interest for each of the N labels to obtain the subsequent trained AI model.

In some embodiments, the system includes an iterative process comprising of alternating between step (a) and step (b) to obtain the subsequent trained AI model, wherein the iterative process is stopped if performance of the prediction of the subsequent trained AI model after restricting the training data based on the updated region of interest exceeds a performance threshold of unrestricted prediction of the subsequent trained AI model.

In yet another aspect, there is described one or more non-transitory computer readable storage mediums storing one or more sequences of instructions, which if executed by one or more processors, causes a method for training an artificial intelligence (AI) model to extract target data from M documents, the method comprising (i) defining a region of interest that ranges between a first boundary location and a second boundary location for each label in each of the M documents, wherein M documents comprise N labels, wherein M is a positive integer greater than 0 and N is a positive integer greater than 1, (ii) summarizing information, in a selected document that is selected from M documents, from a first content location to the first boundary location of the region of interest to obtain a first summary at the first boundary location, wherein the first summary represents context information from the first content location in the selected document to the first boundary location of the region of interest, (iii) summarizing information, in the selected document, from a second content location to the second boundary location of the region of interest to obtain a second summary at the second boundary location, wherein the second summary represents context information from the second boundary location of the region of interest to the second content location in the selected document, (iv) performing a first occurrence of training of the AI model including restricting a training data from the M documents based on the region of interest for each of the N labels to obtain an original trained AI model, and (v) extracting the target data from the M documents using the original trained AI model.

In some embodiments, a subsequent trained AI model is obtained by (a) updating the first summary and the second summary of the region of interest based on a prediction of the original trained AI model and (b) performing a second occurrence of training of the original trained AI model including restricting the training data based on the updated region of interest for each of the N labels to obtain the subsequent trained AI model.

In some embodiments, the first summary and the second summary of the region of interest are updated based at least in part on repositioning of at least one of the first boundary location and the second boundary location to resize the region of interest into an updated region of interest for each of the N labels, wherein the updated region of interest is different from the region of interest.

In some embodiments, the method includes an iterative process comprising of alternating between step (a) and step (b) to obtain the subsequent trained AI model. The iterative process is stopped if performance of the prediction of the subsequent trained AI model after restricting the training data based on the updated region of interest exceeds a performance threshold of unrestricted prediction of the subsequent trained AI model.

A first region of interest of the selected document from the M documents and a second region of interest of the selected document are merged into a third region of interest of the selected document if the first region of interest and the second region of interest are overlapping.

In some embodiments, the first boundary location and the second boundary location for each of the N labels in the M documents are initialized at a first predetermined location and a second predetermined location, respectively, in the selected document and the first summary and the second summary are initialized using at least one of (a) a default value, (b) a value computed using a pre-trained AI model or (c) an AI model that is initialized with default parameter values.

In some embodiments, incremental training of the AI model is performed by (i) initializing the first boundary location and the second boundary location for each of the N labels in the M documents using a trained parameter of the original trained AI model obtained from a previous occurrence and (ii) performing Q repetitions of step (b) after one repetition of step (a), wherein Q is a positive integer for performing incremental training of the AI model.

In some embodiments, the region of interest of at least one of the N labels is expanded by (i) determining (a) a first error obtained in a prediction of the subsequent trained AI model after restricting the training data based on the updated region of interest and (b) a second error obtained in a prediction of the subsequent trained AI model without restricting the training data, (ii) determining that a difference between the first error and the second error is more than a threshold and (iii) expanding the region of interest for next occurrence of performing training of the original trained AI model.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram that illustrates a computing environment in which a computing device is operable to train an artificial intelligence (AI) model to extract target data from M documents comprising N labels according to some embodiments herein;

FIG. 2 is an exemplary screen of the user device of FIG. 1 that illustrates a selected document that is selected from the M documents including N labels of FIG. 1 according to some embodiments herein;

FIG. 3 is a block diagram of the computing device of FIG. 1 according to some embodiments herein;

FIG. 4A is an exemplary screen of the user device of FIG. 1 that illustrates initializing a region of interest in the selected document according to some embodiments herein;

FIG. 4B is an exemplary screen of the user device of FIG. 1 that illustrates restricting the training of the AI model to the region of interest in the selected document according to some embodiments herein;

FIG. 4C is an exemplary screen of the user device of FIG. 1 that illustrates expanding the boundary locations to obtain an updated region of interest in the selected document according to some embodiments herein;

FIG. 4D is an exemplary screen of the user device of FIG. 1 that illustrates extracting target data from a second selected document using the subsequent trained AI model according to some embodiments herein;

FIG. 5 is a flow diagram that illustrates a method for training an AI model to extract target data from M documents comprising N labels according to some embodiments herein; and

FIG. 6 is a block diagram of a schematic diagram of a device used in accordance with embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments.

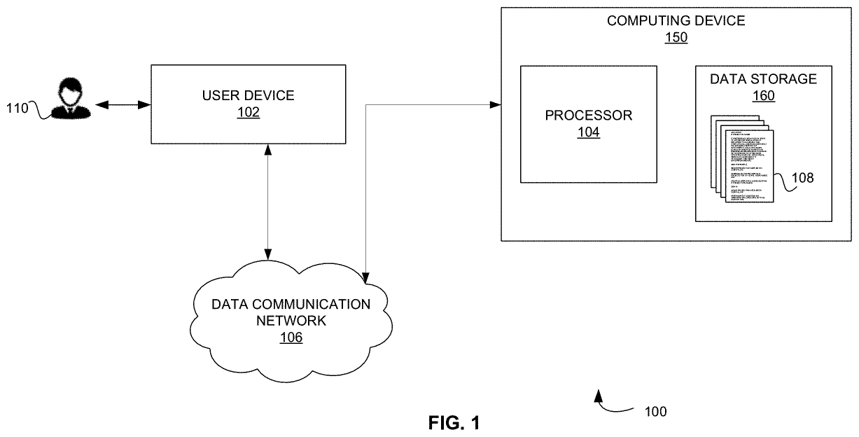

There remains a need for a method for training an artificial intelligence (AI) model to extract target data from M documents including N labels with sufficient accuracy to achieve increase in the speed of training without substantial degradation of performance. Referring now to the drawings, and more particularly to FIGS. 1 through 5, where similar reference characters denote corresponding features consistently throughout the figures, preferred embodiments are shown.

FIG. 1 is a block diagram that illustrates a computing environment 100 in which a computing device 150 is operable to train an artificial intelligence (AI) model to extract target data from M documents including N labels 108 in accordance with an embodiment of the disclosure. The computing environment includes a user device 102, a computing device 150 having a processor 104 and a data storage 160, and a data communication network 106. In some embodiments, the data communication network 106 is a wired network. In some embodiments, the data communication network 106 is a wireless network. In some embodiments, the data communication network 106 is a combination of a wired network and a wireless network. In some embodiments, the data communication network 106 is the Internet.

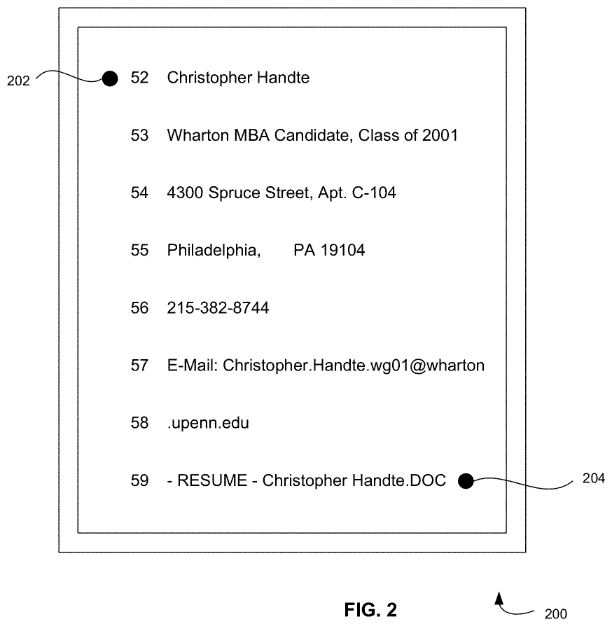

The data storage 160 includes M documents including N labels 108. The data storage 160 represents a storage for the AI model and training data, which is accessed by the computing device 150 for training the AI model, shown in FIG. 2, to extract target data from M documents including N labels 108. The computing device 150 is operable to train the AI model over a training data that includes the M documents, where M is a positive integer greater than 0. In some embodiments, the computing device 150 is operable to train AI models including Long Short-Term Memory (LSTM) networks, and Conditional Random Field (CRF) models. In some embodiments, the AI models are used for extracting target data from one-dimensional signals such as text, electronic signals. Alternatively, in some embodiments, the AI model can be trained to extract target data from two-dimensional signals or images.

The computing device 150 is configured to define, for each of the N labels of the M documents, a region of interest that ranges between a first boundary location and a second boundary location for each label in each of the M documents, wherein M documents comprise N labels, wherein M is a positive integer greater than 0 and N is a positive integer greater than 1. The region of interest is referred to as a contiguous region in a document associated with a label for a set of documents.

The computing device 150 summarizes information, in a selected document that is selected from M documents including N labels 108, from a first content location to the first boundary location of the region of interest to obtain a first summary at the first boundary location, where the first summary represents context information from the first content location in the selected document to the first boundary location of the region of interest. The computing device 150 summarizes information, in the selected document, from a second content location to the second boundary location of the region of interest to obtain a second summary at the second boundary location, where the second summary represents context information from the second boundary location of the region of interest to the second content location in the selected document. The computing device 150 performs a first occurrence of training of the AI model including restricting a training data from the M documents based on the region of interest for each of the N labels to obtain an original trained AI model. To classify some text in a document, other neighbouring text is considered as its context. Information may be summarized by breaking down neighbouring text to extract n-grams, noun phrases, themes, and/or facets present within the text to obtain context information. In some documents in the training data, the region of interest gets expanded around the label that a user 110 has provided, because restricting the region of interest only to what the user has labelled does not retain the same performance as without restricting the training data. A reason why some documents need to get their regions of interest boundaries expanded is some labels by themselves are not enough and need more context from the surrounding words. Expanding the region of interest to capture context information enables the training to converge and have the AI model equivalent in performance to the performance achieved after training without restricting the training data.

The computing device 150 is configured to obtain a subsequent trained AI model by (a) updating the first summary and the second summary of the region of interest based on a prediction of the original trained AI model and (b) performing a subsequent occurrence of training of the original trained AI model including restricting the training data based on the updated region of interest for each of the N labels to obtain the subsequent trained AI model.

In some embodiments, the computing device 150 includes an iterative process comprising of alternating between step (a) and step (b) to obtain the subsequent trained AI model. The iterative process is stopped if performance of the prediction of the subsequent trained AI model after restricting the training data based on the updated region of interest exceeds a performance threshold of unrestricted prediction of the subsequent trained AI model.

The computing device 150 causes the first boundary location and the second boundary location to be inferred automatically. The computing device 150 automatically computes and updates the states for entering and exiting the region of interest and further updates them automatically and approximately.

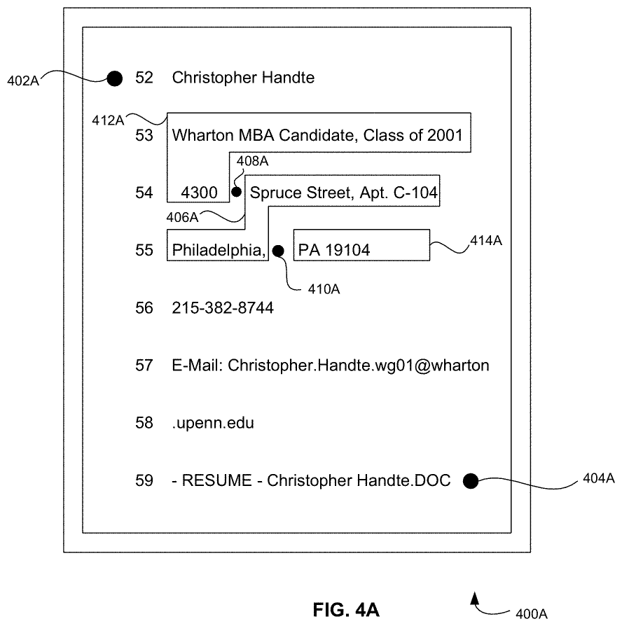

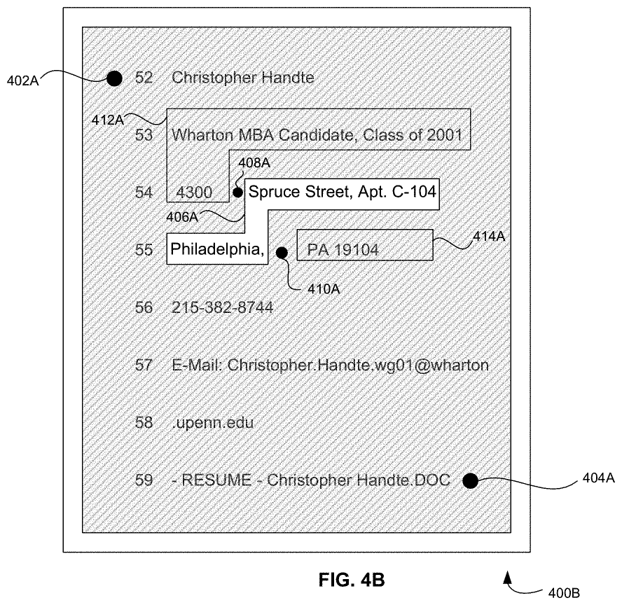

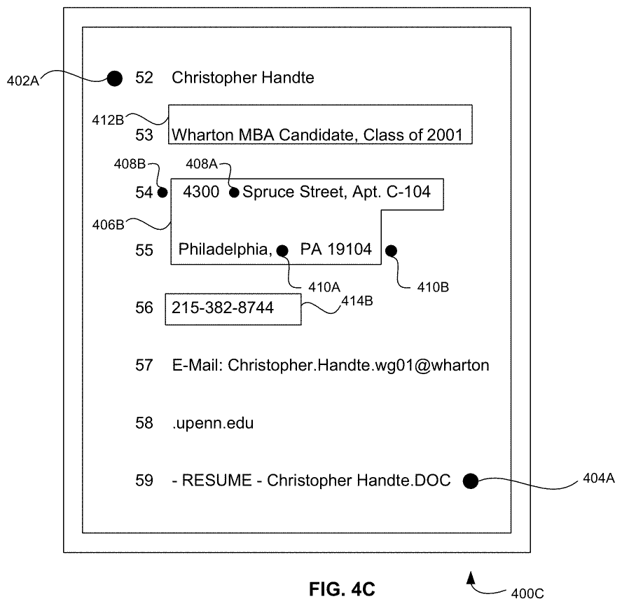

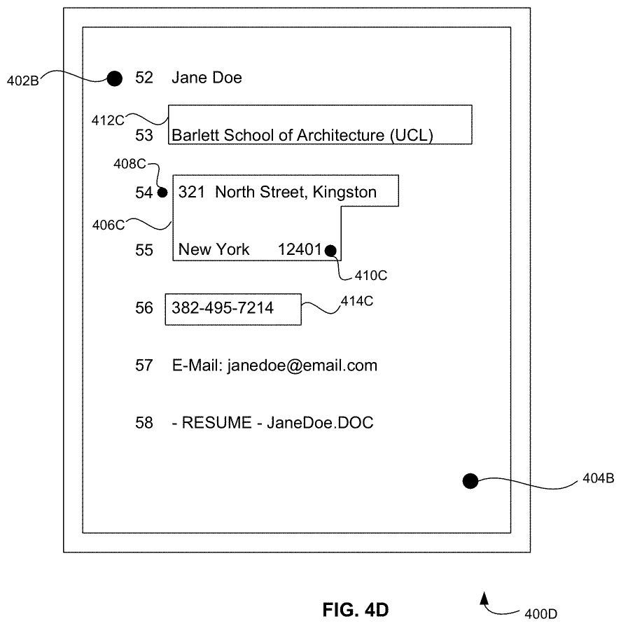

FIG. 2 is an exemplary screen 200 of the user device 102 of FIG. 1 that illustrates a selected document that is selected from the M documents including N labels 108 of FIG. 1 according to some embodiments herein. The selected document is shown to contain an email from a dataset comprising emails. The selected document includes a first content location 202 and a second content location 204. Initializing a region of interest in the selected document is described in FIG. 4A.

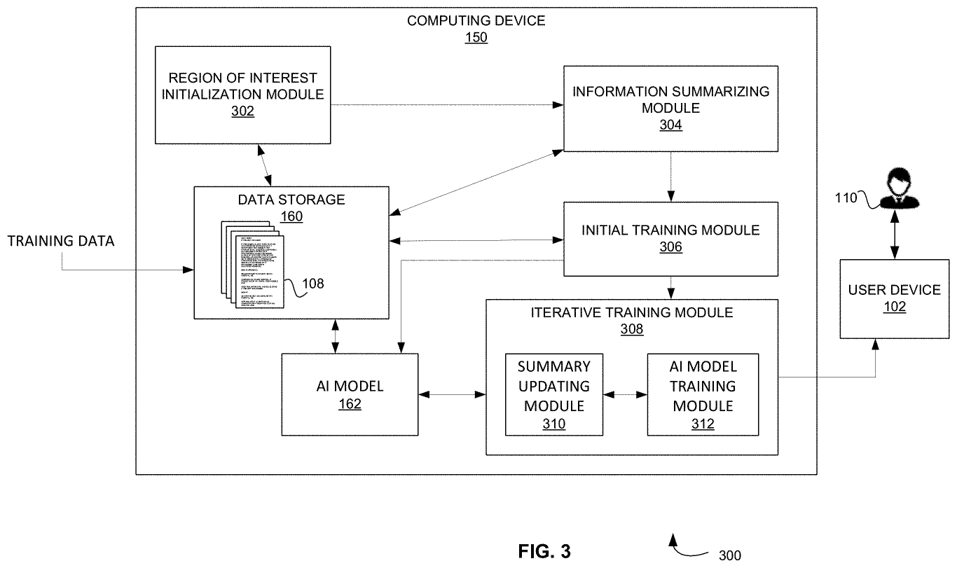

FIG. 3 is a block diagram of the computing device 150 of FIG. 1 according to some embodiments herein. The computing device 150 includes the data storage 160 that is connected to an AI model 162, an information summarizing module 304, an initial training module 306 and an iterative training module 308 that includes a summary updating module 310 and an AI model training module 312. The data storage 160 obtains the training data.

The region of interest initialization module 302 defines, for each of the N labels of the M documents, a region of interest that ranges between a first boundary location and a second boundary location for each label in each of the M documents, wherein M documents comprise N labels, where M is a positive integer greater than 0 and N is a positive integer greater than 1. The information summarizing module 304 summarizes information, in a selected document that is selected from M documents, from a first content location to the first boundary location of the region of interest to obtain a first summary at the first boundary location, where the first summary represents context information from the first content location in the selected document to the first boundary location of the region of interest. The first content location coming before the first boundary location. The information summarizing module 304 selects the first content location at or near the beginning of the document. The information summarizing module 304 summarizes everything between the first content location and the first boundary location. The information summarizing module 304 summarizes information by performing a scan that expands the context information around the region of interest in each document. In some embodiments, the information summarizing module 304 may summarize information by propagating context information in both directions. During the scan, the information summarizing module 304 summarizes information in a state. In some embodiments, a Markov assumption is that the predictions of the AI model 162 after the state are independent of the history before the state. In some embodiments, LSTMs, for example, the context information is summarized by continuous states of hidden units in one directional manner. In some embodiments, CRFs and Markov-based algorithms, the information is carried in a discrete state of a finite state machine. In some embodiments, algorithms like Viterbi, dynamic programming, Expectation-Maximization (EM), Baum-Welch are bi-directional and use both a forward pass and a backward pass of the scan to compute the states. By using the algorithms on the entirety of the selected document, a summary is computed at each location of the selected document. In the forward pass of the scan, for example, the summary at a location X contains all context information contained prior to the location X. The Markov assumption guarantees that given the summary at the location X, the local prediction is independent of the history before the position X.

In some embodiments, the information summarizing module 304 summarizes information, in the selected document, from a second content location to the second boundary location of the region of interest to obtain a second summary at the second boundary location, where the second summary represents context information from the second boundary location of the region of interest to the second content location in the selected document. The second content location coming after the second boundary location. The information summarizing module 304 selects the second content location of the region of interest at or near the end of the document. The information summarizing module 304 summarizes everything between the second boundary location and the second content location in the document. In some embodiments, the boundary location starts a few words from the beginning of the label, for example 5 or 10 words from the beginning of the label. In some embodiments, the second content location starts a few words after the label. For example, 5 or 10 words after the label.

As an example, in some embodiments, the first boundary location and the second boundary location are expanded to 5 words before and after each label in the documents, respectively. The first boundary location and the second boundary location may be a left boundary location and a right boundary location, respectively, i.e., the first boundary location is towards the left of the second boundary location and the second boundary location is towards the right of the first boundary location. Before training of the AI model 162 begins, a full pass over entirety of the training data is done to initialize the first boundary location and the second boundary location. In some embodiments, the left boundary location is initialized by expanding the first boundary of the label with more words to the left and the right boundary location is initialized by expanding the second boundary of the label with more words to the right.

The initial training module 306 performs a first occurrence of training of the AI model 162 including restricting a training data from the M documents based on the region of interest for each of the N labels to obtain an original trained AI model 162. In some embodiments, to obtain the original trained AI model 162, multiple iterations of training of the AI model 162 is performed on the training data but the training is limited only to the regions of interest. Since the regions of interest are typically smaller than entire document and the training is restricted to each region of interest where the labels are, there is achieved an increase in speed of training. However, as the trained AI model 162 summarizes or computes context information that is changing with training, the context information is updated at regular intervals by running the AI model 162 over the entirety of the document. In some embodiments, the iterative training module 308 is configured to obtain a subsequent trained AI model 162. The summary updating module 310 of the iterative training module 308 updates the first summary and the second summary with the original trained AI model 162 to reposition the first boundary location and/or the second boundary location to resize the region of interest into an updated region of interest for each of the N labels, where the updated region of interest is different from the region of interest. Generally, the AI model training module 312 of the iterative training module 308 performs a subsequent iteration of training of the previously trained AI model 162 including restricting the training data based on the updated region of interest for each of the N labels to obtain a subsequently trained AI model 162. In some embodiments, the AI model training module 312 of the iterative training module 308 performs a second iteration of training of the original trained AI model 162 including restricting the training data based on the updated region of interest for each of the N labels to obtain the subsequent trained AI model 162.

After the original trained AI model 162 is obtained, a full pass of training of the original trained AI model 162 is performed over the M documents to update the first boundary location and the second boundary location for each region of interest in each of the M documents. After the full pass of training, trained parameters of the AI model 162 change state probabilities or the first summary and the second summary at the first boundary location and the second boundary location, respectively, of each document. In some embodiments, the training resumes for further iterations with the updated region of interest for each of the N labels. The method for training the AI model 162 includes alternating between (a) training of the AI model 162 and (b) updating of the first summary and the second summary to obtain the updated region of interest for each of the N labels. In some embodiments, training of the AI model 162 includes performing multiple passes limited to the regions of interest that are much smaller than the M documents and updating of the first summary and the second summary performs only one pass but on entirety of the M documents. If the alternating between training and updating converges in two to three repetitions, there is a substantial training speed advantage of the AI model 162 with no substantial degradation in performance of the AI model 162.

In some embodiments, the subsequent trained AI model is obtained by (a) updating the first summary and the second summary of the region of interest based on a prediction of the original trained AI model 162 and (b) performing a second occurrence of training of the original trained AI model 162 including restricting the training data based on the updated region of interest for each of the N labels to obtain the subsequent trained AI model 162. An iterative process comprising of alternating between step (a) and step (b) may be used to obtain the subsequent trained AI model 162. The iterative process is stopped if performance of the prediction of the subsequent trained AI model 162 after restricting the training data based on the updated region of interest exceeds a performance threshold of unrestricted prediction of the subsequent trained AI model 162. To achieve performance of the original trained AI model 162 similar to performance of the AI model 162 without restricting the training data, a verification of error of the AI model 162 may be performed by the user 110. A prediction of the AI model 162 over the whole documents same as prediction of the AI model 162 based on the region of interest is described in an example in the following text.

In some embodiments, a first region of interest of the selected document from the M documents and a second region of interest of the selected document are merged into a third region of interest of the selected document if the first region of interest and the second region of interest are overlapping. In this situation, the first label previously associated with the first region of interest and the second label previously associated with the second region of interest are both associated with the third region of interest.

In some embodiments, the AI model 162 is evaluated, without restricting the training data (unrestricted), to initialize the first boundary location and the second boundary location for each of the N labels in the M documents by expanding (a) the first boundary location for each of the N labels by 0 units before that label and (b) the second boundary location for each of the N labels by P units after that label, where 0 and P are positive integers. In some embodiments, units are words, characters, white spaces or indices of location of text in the document.

In some embodiments, the region of interest is updated after Q iterations of training of the AI model 162, where Q is a positive integer, by (i) updating the first boundary location and/or the second boundary location of the region of interest for each of the N labels using predictions of the original trained AI model 162, and (ii) updating the first summary and the second summary by propagating information to the M documents to obtain an updated region of interest.

In some embodiments, the training is stopped within three repetitions of alternating between step (a) and step (b) to achieve an increase in training speed of the AI model 162 without substantial degradation in performance.

In some embodiments, the first boundary location and the second boundary location for each of the N labels in the M documents are initialized at a first predetermined location and a second predetermined location, respectively, in the selected document and the first summary and the second summary are initialized using at least one of (a) a default value, (b) a value computed using a pre-trained AI model 162 or (c) an AI model 162 that is initialized with default parameter values. During the incremental training of the AI model 162, labels are associated with the training data gradually and the first boundary location and the second boundary location are initialized using the trained parameters of either the first iteration of training the AI model 162 or a previous iteration of training the AI model 162. Hence, an increase in accuracy of the first boundary location and the second boundary location is achieved from the first iteration of training of the AI model 162.

In some embodiments, the region of interest of one or more of the N labels is expanded by (i) determining (a) a first error obtained in a prediction of the subsequent trained AI model 162 after restricting the training data based on the updated region of interest and (b) a second error obtained in a prediction of the subsequent trained AI model 162 without restricting the training data, (ii) determining that a difference between the first error and the second error is more than a threshold and (iii) expanding the region of interest for next occurrence of performing training of the original trained AI model 162. For next iteration of performing training of the original trained AI model 162, in some embodiments the region of interest is doubled in size by repositioning at least one of the first boundary location and the second boundary location using predictions of the original trained AI model 162. An error happens if a label provided by the user 110 to a text segment in the selected document does not match the prediction of the first AI model 162 on the text segment. After an iteration of training, updated predictions on the labeled text segments are obtained and the updated predictions are used to determine errors.

In some embodiments, a first boundary location and a second boundary location of a previous iteration of training the original trained AI model 162 are utilized by performing at least one iteration of incremental training of the original trained AI model 162.

In some embodiments, convergence of the training occurs if the region of interest is expanded to an entirety of the selected document. In some embodiments, convergence of the training occurs by training on region(s) of interest without expanding to entirety of the document. During such convergence of training over a set of documents in the M documents, a speed gain in training of the AI model 162 is obtained. If expanding the region of interest is combined with incremental training, a region of interest associated with a previous iteration of training of the AI model 162 is utilized. After each iteration of training of the AI model 162, it is checked for no errors. If there is an error, another iteration of training of the AI model 162 is performed until performance of the original trained AI model 162 including restricting the training data based on the updated region of interest matches performance of the AI model 162 without restricting the training data. In a worst case scenario, expansion of the region of interest may continue until expanded to entirety of the document if the performance does not match.

In some embodiments, a first boundary location and a second boundary location of a previous iteration of training the original trained AI model 162 are utilized by performing one or more iterations of incremental training of the original trained AI model 162.

As an example, each training session has 50 iterations (numbered 0 to 49) where a cross-entropy error and adaptive learning rates are shown using Broyden—Fletcher—Goldfarb— Shanno (BFGS) with two-way backtracking search. After each training session, documents with enlarged region size are shown. Formula for the region size is 1+10*2∧(size). In an initial iteration, “size of region of interest” is 11 as default, which means all regions of interest are of size 11 (5 units on each side of each labels). Initial size of the region of interest includes the label along with the first boundary location and the second boundary location of the region of interest. There are 219 documents in the training data. The first report is: “ErrorFull: 90, ErrorCropped: 18” meaning that the region of interest predictions has 18 documents that are in error, and 90 documents that are in error if the prediction includes the whole documents. As a result, the documents that are wrong have size of the region of interest increased and a new training session is performed on the new regions of interest. The second report is: “ErrorFull: 5, ErrorCropped: 2” This time, only 3 documents (21, 104, 218) see their region increased: “docId: 21, new size of region of interest: 1 F5T101 docId: 104, new size of region of interest: 2 F16T5 LF19T14 F16T5 LF19T14 F16T10 LF19T11 F16T10 LF19T14 F16T5 LF19T14 F16T5 LF19T14 F16T5 LF19T14 F16T5 LF19T14 F16T5 LF19T14 F16T51 docId: 218, new size of region of interest: 1 F5T16 For a document “104”, the region size is 1+10*2∧2=41. After another training session, the next report is: “ErrorFull: 35, ErrorCropped: 2”. Which means that the system has overtrained on the regions of interest. Sizes of more regions of interest are increased and another iteration is performed: “ErrorFull: 1, ErrorCropped: 1”. Now, the prediction of the AI model 162 over the whole documents is the same as predictions based on the region of interest and the training is stopped after 4 training sessions. The majority of regions are 11, about ⅓^{rd} are 21, 15% are 41, one is 81. If average document length is 3000 words, 4 iterations with an average size of 20 are performed. Since 3000>4*20=80, training resource requirement is 3000 for without restricting and 80 for restricting to region of interest, which is close to 40 times speedup. In the second report, text “F16T5 LF19T14 F16T5 LF19T14 F16T10 LF19T11 F16T10 LF19T14 F16T5 LF19T14 F16T5 LF19T14 F16T5 LF19T14 F16T5 LF19T14 F16T5 LF19T14 F16T5” signifies that document 104 needed expansion of the region of interest while documents 21 and 218 did not need expansion of the region of interest. The boundaries in documents 21 and 218 got detected from the first iteration of training.

FIG. 4A is an exemplary screen 400A of the user device 102 of FIG. 1 that illustrates initializing a region of interest in a selected document according to some embodiments herein. The selected document includes a first content location 402A and a second content location 404A. In some embodiments, by way of an example, a label specifying addresses is selected from the N labels and an address in the selected document is detected. A region of interest 406A is initialed in the selected document that ranges between a first boundary location 408A and a second boundary location 410A encompassing the detected address. The region of interest 406A includes text “Spruce Street, Apt. C-104 Philadelphia”.

Information is summarized in the selected document from the first content location 402A to the first boundary location 408A of the region of interest 406A to obtain a first summary 412A at the first boundary location 408A, where the first summary 412A represents context information “Wharton MBA Candidate, Class of 2001 4300” from the first content location 402A in the selected document to the first boundary location 408A of the region of interest 406A. Similarly, in the selected document, information is summarized from the second content location 404A to the second boundary location 410A of the region of interest 406A to obtain a second summary 414A at the second boundary location 410A, where the second summary 414A represents context information “PA 19104” from the second boundary location 410A of the region of interest 406A to the second content location 404A in the selected document. Information is summarized by performing a scan that propagates context information linearly across the selected document. During the scan information is summarized in a state. Algorithms like Viterbi, dynamic programming, Expectation-Maximization (EM), Baum-Welch are bi-directional and use both a forward pass and a backward pass of the scan to compute the states. By using the algorithms on the entirety of the selected document, a summary is computed at each location of the selected document. In the forward pass of the scan, for example, the summary at a location X contains all context information contained prior to the location X. The Markov assumption guarantees that given the summary at the location X, the local prediction is independent of the history before the position X.

FIG. 4B is an exemplary screen 400B of the user device 102 of FIG. 1 that illustrates restricting the training of the AI model 162 to the region of interest 406A in the selected document according to some embodiments herein. A first iteration of training of the AI model 162 (as shown in FIG. 1) is performed by restricting a training data from the M documents to the region of interest 406A for each of the N labels to obtain an original trained AI model. The AI model 162 (as shown in FIG. 1) is not trained on the portions of the selected document outside the region of interest 406A.

FIG. 4C is an exemplary screen 400C of the user device 102 of FIG. 1 that illustrates expanding the boundary locations to obtain an updated region of interest in the selected document according to some embodiments herein. The first summary 412A and the second summary 414A, as shown in FIGS. 4A and 4B, are updated as the first summary 412B and the second summary 414B, respectively, using predictions of the original trained AI model. The first summary 412B represents context information “Wharton MBA Candidate, Class of 2001” and the second summary 414B represents context information “215-382-8744”. The first boundary location 408A is repositioned to the first boundary location 408B and the second boundary location 410A is repositioned to the second boundary location 410B. Consequently, the region of interest 406A is resized into an updated region of interest 406B for each of the N labels, where the updated region of interest 406B is different from the region of interest 406A. The updated region of interest 406B comprises text “4300 Spruce Street, Apt. C-104 Philadelphia, Pa. 19104”. A second iteration of training of the original trained AI model is performed by restricting the training data based on the updated region of interest 406B for each of the N labels to obtain a subsequent trained AI model.

FIG. 4D is an exemplary screen 400D of the user device 102 of FIG. 1 that illustrates extracting target data from a second selected document using the subsequent trained AI model according to some embodiments herein. The second selected document includes a first content location 402B and a second content location 404B. The second selected document includes a region of interest 406C that ranges from a first boundary location 408C to the second boundary location 410C and includes text “321 North Street, Kingston N.Y. 12401”. The first summary 412C represents context information “Barlett School of Architecture (UCL)” from the first content location 402B in the second selected document to the first boundary location 408C of the region of interest 406C. The second summary 414C represents context information “382-495-7214” from the second content location 404B in the second selected document to the second boundary location 410C of the region of interest 406C.

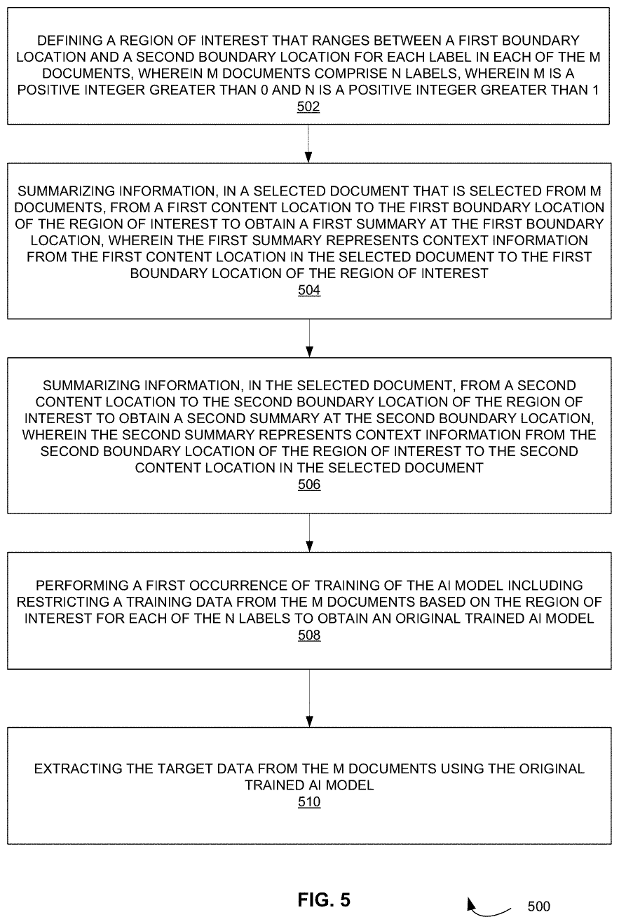

FIG. 5 is a flow diagram 500 that illustrates a method for training an artificial intelligence (AI) model to extract target data from M documents according to some embodiments herein. At step 502, the method 500 includes defining a region of interest that ranges between a first boundary location and a second boundary location for each label in each of the M documents, wherein M documents comprise N labels, wherein M is a positive integer greater than 0 and N is a positive integer greater than 1. At step 504, the method 500 includes summarizing information, in a selected document that is selected from M documents, from a first content location to the first boundary location of the region of interest to obtain a first summary at the first boundary location, wherein the first summary represents context information from the first content location in the selected document to the first boundary location of the region of interest. At step 506, the method 500 includes summarizing information, in the selected document, from a second content location to the second boundary location of the region of interest to obtain a second summary at the second boundary location, wherein the second summary represents context information from the second boundary location of the region of interest to the second content location in the selected document. At step 508, the method 500 includes performing a first occurrence of training of the AI model including restricting a training data from the M documents based on the region of interest for each of the N labels to obtain an original trained AI model. At step 510, the method 500 includes extracting the target data from the M documents using the original trained AI model.

In some embodiments, a subsequent trained AI model is obtained by (a) updating the first summary and the second summary of the region of interest based on a prediction of the original trained AI model and (b) performing a second occurrence of training of the original trained AI model including restricting the training data based on the updated region of interest for each of the N labels to obtain the subsequent trained AI model.

In some embodiments, the method includes an iterative process comprising of alternating between step (a) and step (b) to obtain the subsequent trained AI model, wherein the iterative process is stopped if performance of the prediction of the subsequent trained AI model after restricting the training data based on the updated region of interest exceeds a performance threshold of unrestricted prediction of the subsequent trained AI model.

The method summarizes context information around regions of interest such that training can be performed at high speed without significant loss of performance. The method automatically determines the region size for the regions of interest and represents the context information with sufficient accuracy to both maximize training speed and performance of the AI model.

The embodiments herein may include a computer program product configured to include a pre-configured set of instructions, which if performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which if performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

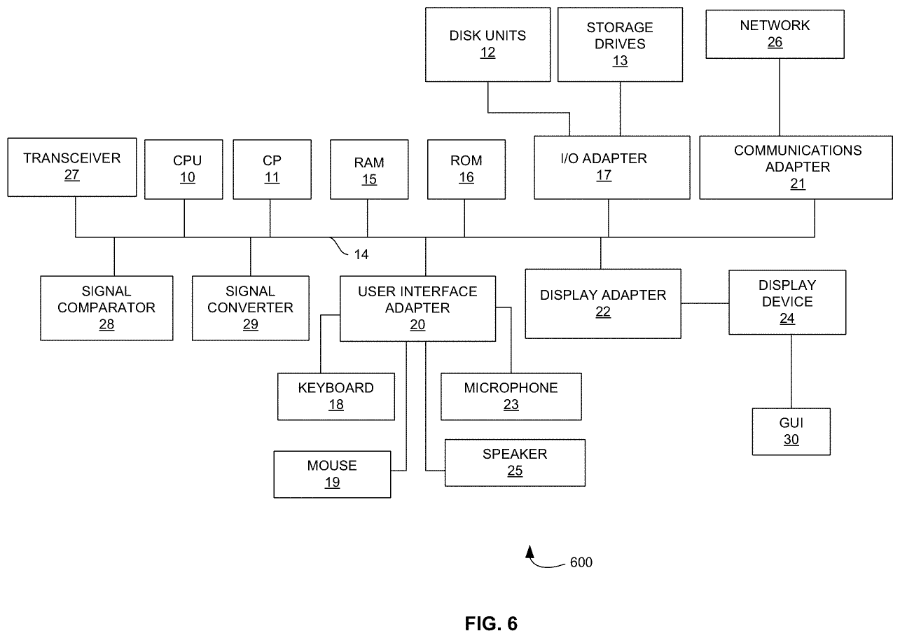

A representative hardware environment for practicing the embodiments herein is depicted in FIG. 6, with reference to FIGS. 1 through 5. This schematic drawing illustrates a hardware configuration of a server/computer system/user device in accordance with the embodiments herein. The user device includes at least one processing device 10 and a cryptographic processor 11. The special-purpose CPU 10 and the cryptographic processor (CP) 11 may be interconnected via system bus 14 to various devices such as a random access memory (RAM) 15, read-only memory (ROM) 16, and an input/output (I/O) adapter 17. The I/O adapter 17 can connect to peripheral devices, such as disk units 12 and tape drives 13, or other program storage devices that are readable by the system. The user device can read the inventive instructions on the program storage devices and follow these instructions to execute the methodology of the embodiments herein. The user device further includes a user interface adapter 20 that connects a keyboard 18, mouse 19, speaker 25, microphone 23, and/or other user interface devices such as a touch screen device (not shown) to the bus 14 to gather user input. Additionally, a communication adapter 21 connects the bus 14 to a data processing network 26, and a display adapter 22 connects the bus 14 to a display device 24, which provides a graphical user interface (GUI) 30 of the output data in accordance with the embodiments herein, or which may be embodied as an output device such as a monitor, printer, or transmitter, for example. Further, a transceiver 27, a signal comparator 28, and a signal converter 29 may be connected with the bus 14 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor-implemented method for training an artificial intelligence (AI) model to extract target data from M documents, comprising:
defining a region of interest that ranges between a first boundary location and a second boundary location for each label in each of the M documents, wherein M documents comprise N labels, wherein M is a positive integer greater than 0 and N is a positive integer greater than 1;
summarizing information, in a selected document that is selected from M documents, from a first content location to the first boundary location of the region of interest to obtain a first summary at the first boundary location, wherein the first summary represents context information from the first content location in the selected document to the first boundary location of the region of interest;
summarizing information, in the selected document, from a second content location to the second boundary location of the region of interest to obtain a second summary at the second boundary location, wherein the second summary represents context information from the second boundary location of the region of interest to the second content location in the selected document;
performing a first occurrence of training of the AI model including restricting a training data from the M documents based on the region of interest for each of the N labels to obtain an original trained AI model; and
extracting the target data from the M documents using the original trained AI model.

2. The processor-implemented method of claim 1, further comprising obtaining a subsequent trained AI model by:
(a) updating the first summary and the second summary of the region of interest based on a prediction of the original trained AI model; and
(b) performing a second occurrence of training of the original trained AI model including restricting the training data based on the updated region of interest for each of the N labels to obtain the subsequent trained AI model.

3. The processor-implemented method of claim 1, wherein the first summary and the second summary of the region of interest are updated based at least in part on repositioning of at least one of the first boundary location and the second boundary location to resize the region of interest into an updated region of interest for each of the N labels, wherein the updated region of interest is different from the region of interest.

4. The processor-implemented method of claim 2, further comprising an iterative process comprising of alternating between step (a) and step (b) to obtain the subsequent trained AI model, wherein the iterative process is stopped if performance of the prediction of the subsequent trained AI model after restricting the training data based on the updated region of interest exceeds a performance threshold of unrestricted prediction of the subsequent trained AI model.

5. The processor-implemented method of claim 1, wherein a first region of interest of the selected document from the M documents and a second region of interest of the selected document are merged into a third region of interest of the selected document if the first region of interest and the second region of interest are overlapping.

6. The processor-implemented method of claim 1, wherein the first boundary location and the second boundary location for each of the N labels in the M documents are initialized at a first predetermined location and a second predetermined location, respectively, in the selected document and the first summary and the second summary are initialized using at least one of (a) a default value, (b) a value computed using a pre-trained AI model or (c) an AI model that is initialized with default parameter values.

7. The processor-implemented method of claim 2, wherein incremental training of the AI model is performed by:
initializing the first boundary location and the second boundary location for each of the N labels in the M documents using a trained parameter of the original trained AI model obtained from a previous occurrence; and
performing Q repetitions of step (b) after one repetition of step (a), wherein Q is a positive integer for performing incremental training of the AI model.

8. The processor-implemented method of claim 2, further comprising expanding the region of interest of at least one of the N labels by:
determining (a) a first error obtained in a prediction of the subsequent trained AI model after restricting the training data based on the updated region of interest and (b) a second error obtained in a prediction of the subsequent trained AI model without restricting the training data;
determining that a difference between the first error and the second error is more than a threshold; and
expanding the region of interest for next occurrence of performing training of the original trained AI model.

9. The processor-implemented method of claim 8, further comprising utilizing a first boundary location and a second boundary location of a previous iteration of training the original trained AI model by performing at least one iteration of incremental training of the original trained AI model.

10. A system for training an artificial intelligence (AI) model to extract target data from M documents, comprising: a processor and a non-transitory computer readable storage medium storing one or more sequences of instructions, which if executed by the processor, performs a method comprising:
defining a region of interest that ranges between a first boundary location and a second boundary location for each label in each of the M documents, wherein M documents comprise N labels, wherein M is a positive integer greater than 0 and N is a positive integer greater than 1;
summarizing information, in a selected document that is selected from M documents, from a first content location to the first boundary location of the region of interest to obtain a first summary at the first boundary location, wherein the first summary represents context information from the first content location in the selected document to the first boundary location of the region of interest;
summarizing information, in the selected document, from a second content location to the second boundary location of the region of interest to obtain a second summary at the second boundary location, wherein the second summary represents context information from the second boundary location of the region of interest to the second content location in the selected document;
performing a first occurrence of training of the AI model including restricting a training data from the M documents based on the region of interest for each of the N labels to obtain an original trained AI model; and
extracting the target data from the M documents using the original trained AI model.

11. The system of claim 10, further comprising obtaining a subsequent trained AI model by:
(a) updating the first summary and the second summary of the region of interest based on a prediction of the original trained AI model; and
(b) performing a second occurrence of training of the original trained AI model including restricting the training data based on the updated region of interest for each of the N labels to obtain the subsequent trained AI model.

12. The system of claim 10, further comprising an iterative process comprising of alternating between step (a) and step (b) to obtain the subsequent trained AI model, wherein the iterative process is stopped if performance of the prediction of the subsequent trained AI model after restricting the training data based on the updated region of interest exceeds a performance threshold of unrestricted prediction of the subsequent trained AI model.

13. One or more non-transitory computer readable storage mediums storing one or more sequences of instructions, which if executed by one or more processors, causes a method for training an artificial intelligence (AI) model to extract target data from M documents, the method comprising:
defining a region of interest that ranges between a first boundary location and a second boundary location for each label in each of the M documents, wherein M documents comprise N labels, wherein M is a positive integer greater than 0 and N is a positive integer greater than 1;
summarizing information, in a selected document that is selected from M documents, from a first content location to the first boundary location of the region of interest to obtain a first summary at the first boundary location, wherein the first summary represents context information from the first content location in the selected document to the first boundary location of the region of interest;
summarizing information, in the selected document, from a second content location to the second boundary location of the region of interest to obtain a second summary at the second boundary location, wherein the second summary represents context information from the second boundary location of the region of interest to the second content location in the selected document;
performing a first occurrence of training of the AI model including restricting a training data from the M documents based on the region of interest for each of the N labels to obtain an original trained AI model; and
extracting the target data from the M documents using the original trained AI model.

14. The one or more non-transitory computer readable storage mediums storing the one or more sequences of instructions of claim 13, further comprising obtaining a subsequent trained AI model by:
(a) updating the first summary and the second summary of the region of interest based on a prediction of the original trained AI model; and
(b) performing a second occurrence of training of the original trained AI model including restricting the training data based on the updated region of interest for each of the N labels to obtain the subsequent trained AI model.

15. The one or more non-transitory computer readable storage mediums storing the one or more sequences of instructions of claim 13, wherein the first summary and the second summary of the region of interest are updated based at least in part on repositioning of at least one of the first boundary location and the second boundary location to resize the region of interest into an updated region of interest for each of the N labels, wherein the updated region of interest is different from the region of interest.

16. The one or more non-transitory computer readable storage mediums storing the one or more sequences of instructions of claim 13, further comprising an iterative process comprising of alternating between step (a) and step (b) to obtain the subsequent trained AI model, wherein the iterative process is stopped if performance of the prediction of the subsequent trained AI model after restricting the training data based on the updated region of interest exceeds a performance threshold of unrestricted prediction of the subsequent trained AI model.

17. The one or more non-transitory computer readable storage mediums storing the one or more sequences of instructions of claim 13, wherein a first region of interest of the selected document from the M documents and a second region of interest of the selected document are merged into a third region of interest of the selected document if the first region of interest and the second region of interest are overlapping.

18. The one or more non-transitory computer readable storage mediums storing the one or more sequences of instructions of claim 13, wherein the first boundary location and the second boundary location for each of the N labels in the M documents are initialized at a first predetermined location and a second predetermined location, respectively, in the selected document and the first summary and the second summary are initialized using at least one of (a) a default value, (b) a value computed using a pre-trained AI model or (c) an AI model that is initialized with default parameter values.

19. The one or more non-transitory computer readable storage mediums storing the one or more sequences of instructions of claim 13, wherein incremental training of the AI model is performed by:
initializing the first boundary location and the second boundary location for each of the N labels in the M documents using a trained parameter of the original trained AI model obtained from a previous occurrence; and
performing Q repetitions of step (b) after one repetition of step (a), wherein Q is a positive integer for performing incremental training of the AI model.

20. The one or more non-transitory computer readable storage mediums storing the one or more sequences of instructions of claim 13, further comprising expanding the region of interest of at least one of the N labels by:
determining (a) a first error obtained in a prediction of the subsequent trained AI model after restricting the training data based on the updated region of interest and (b) a second error obtained in a prediction of the subsequent trained AI model without restricting the training data;
determining that a difference between the first error and the second error is more than a threshold; and
expanding the region of interest for next occurrence of performing training of the original trained AI model.

21. The one or more non-transitory computer readable storage mediums storing the one or more sequences of instructions of claim 14, further comprising utilizing a first boundary location and a second boundary location of a previous iteration of training the original trained AI model by performing at least one iteration of incremental training of the original trained AI model.
